(19) United States
(12) Patent Application Publication
(10) Pub. No.: US 2026/0005005 A1
(43) Pub. Date: Jan. 1, 2026

(54) ELECTRON TUBE

(71) Applicant: HAMAMATSU PHOTONICS K.K., Hamamatsu-shi, Shizuoka (JP)

(72) Inventors: Takeru YAGI, Hamamatsu-shi, Shizuoka (JP); Hiroyuki WATANABE, Hamamatsu-shi, Shizuoka (JP); Yasumasa HAMANA, Hamamatsu-shi, Shizuoka (JP); Takamasa IKEDA, Hamamatsu-shi, Shizuoka (JP); Terunori KAWAI, Hamamatsu-shi, Shizuoka (JP); Kenta KASUYA, Hamamatsu-shi, Shizuoka (JP)

(73) Assignee: HAMAMATSU PHOTONICS K.K., Hamamatsu-shi, Shizuoka (JP)

(21) Appl. No.: 18/880,387

(22) PCT Filed: Nov. 7, 2023
(86) PCT No.: PCT/JP2023/040061

§ 371 Date: Dec. 31, 2024

(30) Foreign Application Priority Data
Mar. 14, 2023 (JP) 2023-039610

(51) Int. Cl. H01J 43/18; H01J 43/10

(52) U.S. Cl. CPC H01J 43/18; H01J 43/10

(57) ABSTRACT

An electron tube includes: a photoelectric surface converting incident light into photoelectrons; a plurality of dynodes and an anode; an insulating substrate holding the dynodes and the anode in a state where the dynodes are electrically insulated from each other, and the dynode and the anode are electrically insulated from each other; and a housing accommodating the dynodes, the anode, and the insulating substrate, wherein the insulating substrate includes: a base layer made of a polycrystalline material and having an electrical insulation property; an intermediate layer made of an amorphous material and having an electrical insulation property; and a surface layer made of a material containing carbon and being smaller in electric resistance than the intermediate layer.

### TECHNICAL FIELD

The present disclosure relates to an electron tube.

### BACKGROUND ART

As an example of an electron tube, a photomultiplier tube has been known. The photomultiplier tube includes, for example, a photoelectric cathode including a photoelectric surface that converts incident light into photoelectrons; a multiplier that multiplies the photoelectrons by secondary electron emission based on the incident photoelectrons; and an anode that collects the secondary electrons obtained by the multiplication.

The housing of an electron tube accommodates a substrate having an electrical insulation property (insulating substrate) to hold electrodes. For example, in the photomultiplier tube described in Patent Literature 1, a ceramic substrate constituting the insulating substrate has a chromium oxide film formed on its surface in order to improve the withstand voltage characteristic between electrodes when the insulating substrate is charged.

### CITATION LIST

### Patent Literature

Patent Literature 1: U.S. Pat. No. 4,604,545

### SUMMARY OF INVENTION

### Technical Problem

In addition to the above charging problem, the insulating substrate arranged inside the housing of an electron tube may have a problem that electrons are incident to the polycrystalline ceramic to cause light emission. In the light emission from the insulating substrate, the emitted light is incident to the photoelectric surface, thereby causing an increase in dark current. Therefore, for an electron tube having a photoelectric surface, a technique capable of suppressing both charging and light emission of the insulating substrate has been demanded.

The present disclosure has been made to solve the above problems, and an object thereof is to provide an electron tube capable of suppressing both charging and light emission of the insulating substrate.

### Solution to Problem

In an aspect of the present disclosure, the electron tube includes: a photoelectric surface converting incident light into photoelectrons; a plurality of electrodes; an insulating substrate holding the electrodes in a state where the electrodes are electrically insulated from each other; and a housing accommodating the electrodes and the insulating substrate, wherein the insulating substrate includes: a base layer made of a polycrystalline material and having an electrical insulation property; an intermediate layer made of an amorphous material and having an electrical insulation property; and a surface layer made of a material containing carbon and being smaller in electric resistance than the intermediate layer.

In the electron tube, the base layer having an electrical insulation property is made of a polycrystalline material. Thereby, the strength and the electrical insulation property of the entire insulating substrate can be sufficiently secured. On the base layer having an electrical insulation property, an intermediate layer made of an amorphous material and having an electrical insulation property is provided. With the intermediate layer, it is possible to suppress incidence of electrons to the base layer, which is a polycrystalline material, and it is possible to suppress light emission from the base layer due to incidence of the electrons. When the intermediate layer having an electrical insulation property is located on the surface of the insulating substrate, the surface is easily charged. However, the electron tube is provided with a surface layer made of a material containing carbon and being smaller in electric resistance than the intermediate layer. Thereby, the electric resistance of the surface of the insulating substrate becomes small, and charging on the surface can be suppressed. Therefore, the electron tube can suppress both charging and light emission of the insulating substrate.

The surface layer may further contain an alkali metal. When the surface layer further contains an alkali metal, the insulating substrate can have a more appropriately reduced surface electric resistance. Therefore, it is possible to more reliably suppress the charging of the surface of the insulating substrate.

The thickness of the intermediate layer may be larger than the thickness of the surface layer. When the thickness of the intermediate layer is sufficiently secured, incidence of electrons to the base layer can be effectively suppressed. Therefore, it is possible to more reliably suppress the light emission from the insulating substrate.

Optionally, the material containing carbon includes, as a base material, a material containing at least one of a metal oxide, a metal nitride, and a metal fluoride, and includes carbon in the base material. In this case, the electric resistance of the surface layer can be appropriately smaller than that of the intermediate layer.

The intermediate layer and the surface layer may be provided at least on a first surface of the base layer on a side of the electrode and a second surface of the base layer on a side opposite to the electrode. In this case, when the insulating substrate is provided with the intermediate layer and the surface layer on its surface to which electrons are easily incident, it is possible to further effectively suppress both charging and light emission of the insulating substrate.

The intermediate layer and the surface layer may be provided on a side surface connecting the first surface and the second surface. In this case, the first surface and the second surface can be electrically connected with each other to further reliably suppress charging of the surface of the insulating substrate, and to suppress light emission due to electron incidence to the side surface. Thereby, it is possible to further improve the effect of suppressing both charging and light emission of the insulating substrate.

Optionally, the base layer has an insertion hole inserted with a holding member holding the electrode, and the intermediate layer and the surface layer are provided on the inner surface of the insertion hole. Through the electrodes, electrons multiply and pass. Therefore, electrons are easily incident to the vicinity of the insertion hole into which the holding member is inserted. Therefore, when the intermediate layer and the surface layer are provided on the inner surface of the insertion hole, it is possible to further improve the effect of suppressing both charging and light emission of the insulating substrate.

The intermediate layer and the surface layer may be provided on the entire surface of the base layer. Thereby, it is possible to further improve the effect of suppressing both charging and light emission throughout all positions of the insulating substrate.

Optionally, the intermediate layer and the surface layer are made of an identical material, and the content of an alkali metal in the intermediate layer is smaller than the content of an alkali metal in the surface layer. When the intermediate layer and the surface layer are made of an identical material, it is possible to improve easiness in production of these layers. In addition, the content of an alkali metal in the intermediate layer is smaller than the content of an alkali metal in the surface layer. Thereby, even when the intermediate layer and the surface layer are made of an identical material, the surface layer can be electrically conductive while the intermediate layer has an electrical insulation property. Therefore, it is possible to suppress both charging and light emission of the insulating substrate.

### Advantageous Effects of Invention

According to the present disclosure, it is possible to suppress both charging and light emission of the insulating substrate.

### BRIEF DESCRIPTION OF DRAWINGS

FIG. 1 is a cross-sectional view illustrating the internal configuration of an electron tube according to an embodiment of the present disclosure.

FIG. 2 is a perspective view of a multiplier and an insulating substrate.

FIG. 3 is an enlarged cross-sectional view of a main part of an insulating substrate.

FIG. 4 is a chart showing the results of a confirmation test for the light emission-suppressing effect in the present disclosure.

### DESCRIPTION OF EMBODIMENTS

Hereinafter, a preferred embodiment of the electron tube according to an aspect of the present disclosure will be described in detail with reference to the drawings.

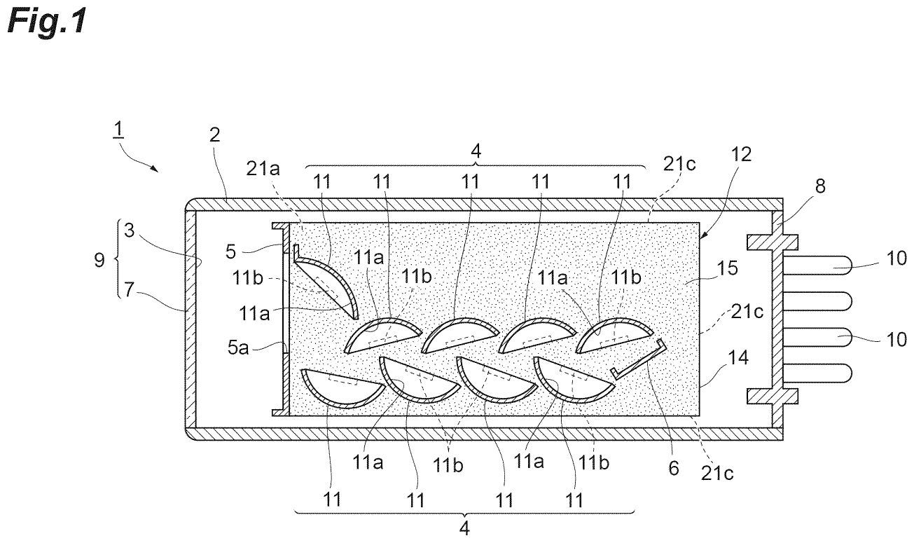

FIG. 1 is a cross-sectional view illustrating the internal configuration of the electron tube according to an embodiment of the present disclosure. In the embodiment, an electron tube 1 is configured as a photomultiplier tube. The electron tube 1 includes a housing 2 made of, for example, Kovar metal or glass. Inside the housing 2, a photoelectric surface (photoelectric cathode) 3 that converts incident light into photoelectrons, a focusing electrode 5 that leads the photoelectrons emitted from the photoelectric surface 3 to a multiplier 4, the multiplier 4 that multiplies the photoelectrons as secondary electrons, and an anode 6 that collects the secondary electrons multiplied by the multiplier 4 are accommodated.

The housing 2 has a substantially cylindrical shape having openings at both ends. At one end of the housing 2, the opening is provided with an entrance window 7 made of, for example, glass. At the other end of the housing 2, the opening is provided with a stem 8 made of, for example, metal or glass. The inside of the housing 2 is hermetically sealed by the entrance window 7 and the stem 8. The housing 2, the entrance window 7, and the stem 8 form a vacuum container, and the inside of the housing 2 is maintained in a high vacuum state. The photoelectric surface 3 is formed on the vacuum side surface of the entrance window 7. The entrance window 7 and the photoelectric surface 3 constitute a photoelectric cathode. The stem 8 is penetrated by a plurality of stem pins 10. Each stem pin 10 is electrically connected to the photoelectric surface 3, the focusing electrode 5, the multiplier 4, and the anode 6.

The photoelectric surface 3 includes a photoelectric conversion layer that converts incident light into photoelectrons. More preferably, in the photoelectric surface 3, an electron emission layer, which facilitates emission of the photoelectrons generated in the photoelectric conversion layer to the internal space of the housing 2, is provided on the internal space side in the photoelectric conversion layer. Among the photoelectric conversion layer and the electron emission layer, at least the electron emission layer contains an alkali metal such as cesium, for example. Also in the photoelectric conversion layer, for example, alkali metals such as cesium, potassium, and sodium may be contained. In the embodiment, the photoelectric surface 3 contains an alkali metal derived from at least one of the photoelectric conversion layer and the electron emission layer.

The focusing electrode 5 has, for example, a cup shape. At the central portion of the focusing electrode 5, for example, an opening 5a having a cross sectional circular shape is provided. The focusing electrode 5 is arranged such that the opening 5a faces the photoelectric surface 3. The anode 6 has, for example, a linear shape or a flat plate shape. The anode 6 is arranged behind the multiplier 4. A mesh electrode may be attached to the opening 5a of the focusing electrode 5 or between the anode 6 and the multiplier 4.

The multiplier 4, arranged between the focusing electrode 5 and the anode 6, is configured by dynodes (electrodes) 11 in a so-called line focus type multi-stage. The dynode 11 in each stage has a secondary electron surface 11a that multiplies photoelectrons as secondary electrons. Each of the secondary electron surfaces 11a has, for example, a cross sectional arcuate shape. The secondary electron surfaces 11a and 11a between the adjacent dynodes 11 and 11 are arranged to face each other. For example, the dynode 11 in the first stage is applied with a negative potential having a voltage equal to that of the focusing electrode 5. The dynode 11 in the nth stage is applied with a negative potential having an absolute value smaller than that of the dynode 11 in the (n−1) th stage. The potential of the anode 6 is regarded as 0 V.

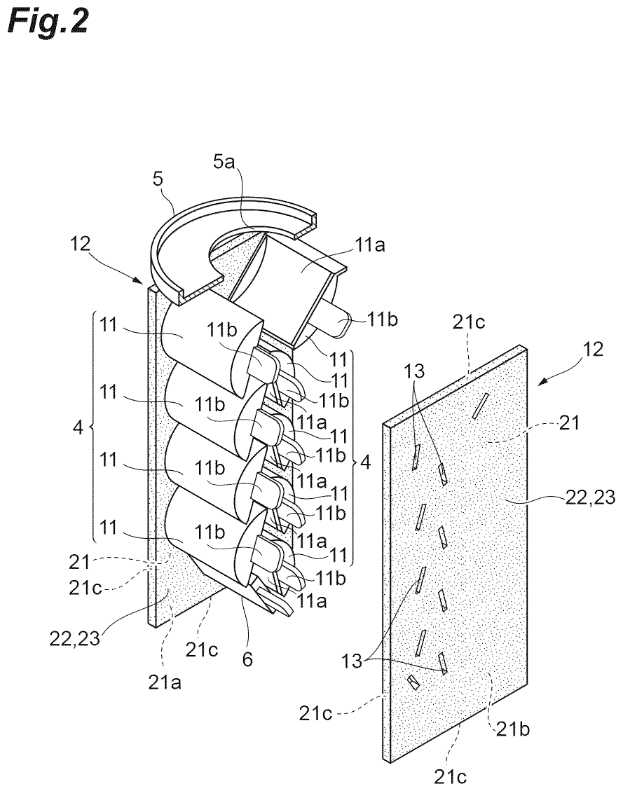

At both ends of each dynode 11 in the longitudinal direction, holding members 11b are provided to hold the dynode 11 in the housing 2. In order to hold the dynode 11 in the housing 2, a pair of insulating substrates 12 and 12 is used as illustrated in FIG. 2. The insulating substrate 12 is provided with a plurality of insertion holes 13 into which the holding members 11b of each dynode 11 are inserted. The holding members 11b of each dynode 11 are inserted into the insertion holes 13, and each dynode 11 is sandwiched between the pair of insulating substrates 12 and 12, whereby each dynode 11 is held in the housing 2 in an electrically insulated state. In the embodiment, the anode 6 is also held in the housing 2 in a state where the anode 6 is electrically insulated from each dynode 11 in a similar structure.

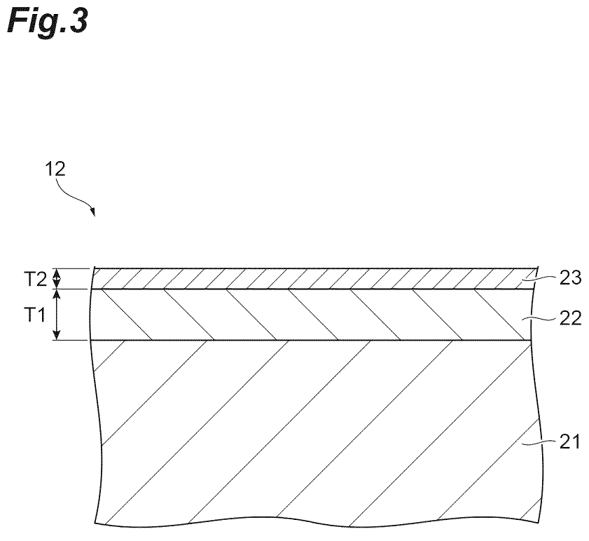

Next, the above-described insulating substrate 12 will be described in more detail. FIG. 3 is an enlarged cross-sectional view of a main part of the insulating substrate. As illustrated in FIG. 3, the insulating substrate 12 includes a base layer 21, an intermediate layer 22, and a surface layer 23.

The base layer 21 serves as a base of the insulating substrate 12. The base layer 21 is made of a polycrystalline material and has an electrical insulation property. Examples of the polycrystalline material having an electrical insulation property include a ceramic material. When the electron tube 1 is a photomultiplier tube as in the embodiment, for example, a ceramic using white alumina made of aluminum oxide (Al₂O₃) or the like can be used. In the embodiment, the base layer 21 has a rectangular plate shape (substrate), where the long side is defined as the extending direction of the housing 2 (direction connecting the entrance window 7 and the stem 8), and the short side is defined as the direction orthogonal thereto.

The base layer 21 has a first surface 21a on the side of the electrode (each dynode 11 and the anode 6), a second surface 21b on the side opposite to the electrode (housing 2), and four side surfaces 21c connecting the first surface 21a and the second surface 21b (see FIG. 2). All of the plurality of insertion holes 13 described above are provided so as to penetrate the base layer 21 through the first surface 21a and the second surface 21b.

The intermediate layer 22 suppresses incidence of electrons to the base layer 21, which is made of a polycrystalline material. The intermediate layer 22 is made of an amorphous material and has an electrical insulation property. That is, the intermediate layer 22 is formed of an electrically insulating amorphous layer. Examples of the amorphous material include alumina, which is aluminum oxide (Al₂O₃). Examples of other amorphous materials include glass, metal oxides, metal nitrides, and metal fluorides. In the embodiment, the amorphous material itself has an electrical insulation property, but the intermediate layer 22 may have an electrical insulation property by adding a material having an electrical insulation property to an amorphous material.

The surface layer 23 reduces the electric resistance of the surface of the insulating substrate 12 to suppress charging on the surface. The electric resistance of the surface layer 23 is smaller than the electric resistance of the intermediate layer 22, and the surface layer 23 exhibits conductivity. The surface layer 23 is made of a material containing carbon (C). Carbon in the surface layer 23 may be unevenly distributed near the surface of the surface layer 23, or may be uniformly or randomly dispersed throughout the surface layer 23.

Examples of the material serving as the base material of the material containing carbon include magnesium oxide (MgO), and alkone, which is an organic-inorganic hybrid material. Examples of other materials for the base material include metal oxides (Be, Mg, Ba, Sc, Y, lanthanoid (La, Ce, Pr, Nd, Sm, Eu, Gd, Tb, Dy, Ho, Er, Tm, Yb, Lu), Ti, Zr, Hf, Zn, B, Al, Ga, In, Si), metal nitrides (Be, Y, B, Al, Ga, Si, Ge), and metal fluorides (Li, Na, Mg, Ca, Sr, Ba, Sc, Y, lanthanoid (La, Ce, Pr, Nd, Sm, Eu, Gd, Tb, Dy, Ho, Er, Tm, Yb, Lu), Zr, Hf, Zn, Al, Ga, In).

As described above, preferably, the material containing carbon includes, as a base material, a material containing at least one of a metal oxide, a metal nitride, and a metal fluoride, and includes carbon in the base material. In the embodiment, the surface layer 23 is also made of an amorphous material. That is, the surface layer 23 is constituted by a conductive amorphous layer.

In the embodiment, the surface layer 23 contains an alkali metal. Examples of the alkali metal include Li, Na, K, Rb, and Cs. In the embodiment, the alkali metal contained in the surface layer 23 is, for example, at least a part of the material for forming the photoelectric surface 3. In the embodiment, in the step of forming the photoelectric surface 3, a part of the alkali metal constituting the photoelectric surface 3 is incorporated into the surface layer 23 to form the surface layer 23 containing the alkali metal. In this case, since the surface layer 23 contains carbon, the alkali metal can be more efficiently incorporated into the surface layer 23.

The intermediate layer 22 and the surface layer 23 are provided at least on the first surface 21a and the second surface 21b of the base layer 21. The intermediate layer 22 and the surface layer 23 may be provided on the side surface 21c, or may be provided on the inner surface of the insertion hole 13. In the embodiment, the intermediate layer 22 and the surface layer 23 are provided on the entire surface of the base layer 21. That is, in the embodiment, the intermediate layer 22 and the surface layer 23 are provided on the entire first surface 21a, the entire second surface 21b, the entire four side surfaces 21c, and the entire inner surface of each insertion hole 13.

Examples of the region where the intermediate layer 22 and the surface layer 23 are formed include, for creeping discharge, a region corresponding to between electrodes applied with a voltage of 100 V or more. For gap discharge, examples thereof include a region corresponding to the anode 6 to which a strong electric field (for example, 200 V/cm or more) is applied. In the embodiment, examples of the region where the intermediate layer 22 and the surface layer 23 are formed with the highest priority include a region corresponding to the anode 6 and the dynode 11 in the final stage in the first surface 21a and the second surface 21b (the region overlapping the anode 6 and the dynode 11 in the final stage when viewed from the facing direction of the pair of insulating substrates 12 and 12). When the first surface 21a and the second surface 21b of the insulating substrate 12 is divided into two regions at the center in the long side direction of the base layer 21, the intermediate layer 22 and the surface layer 23 are preferably formed, for example, in at least the half region on the anode 6 side.

In the embodiment, the thickness T1 of the intermediate layer 22 is larger than the thickness T2 of the surface layer 23. The ratio of the thickness T2 of the surface layer 23 to the thickness T1 of the intermediate layer 22 (T2/T1) is, for example, about 1 to 200000. For example, the thickness T1 of the intermediate layer 22 is about 10 nm to several hundred μm, and the thickness T2 of the surface layer 23 is about 3 to 10 nm.

For example, the intermediate layer 22 and the surface layer 23 are formed by atomic layer deposition method (ALD). The atomic layer deposition method is a method in which an adsorption step of molecules of a compound, a film formation step by reaction, and a purge step of removing excess molecules are repeatedly performed to deposit atomic layers one by one and thereby obtain a thin film.

The film formation cycle using the atomic layer deposition method includes the film formation cycle of the intermediate layer 22 and the film formation cycle of the surface layer 23. For example, when the constituent material of the intermediate layer 22 is alumina (Al₂O₃), in the film formation cycle of the intermediate layer 22, for example, an H₂O adsorption step, a H₂O purge step, a trimethylaluminum adsorption step, and a trimethylaluminum purge step are performed in this order. Furthermore, for example, when the constituent material of the surface layer 23 is MgO (MgO containing carbon), in the film formation cycle of the surface layer 23, for example, a H₂O adsorption step, a H₂O purge step, an adsorption stroke of a magnesium-containing organometallic, and a purge step of a magnesium-containing organometallic are performed in this order.

When the intermediate layer 22 made of alumina (Al₂O₃) having a thickness of 30 nm and the surface layer 23 made of MgO (MgO containing carbon) having a thickness of 5 nm are formed on the surface of the base layer 21 by the atomic layer deposition method, the film formation cycle of alumina (Al₂O₃) is performed 300 times, and then the film formation cycle of MgO (MgO containing carbon) is performed 40 times. As a result, the intermediate layer 22 and the surface layer 23 having a total thickness of 35 nm can be formed on the surface of the base layer 21.

The intermediate layer 22 can be formed by a method other than the atomic layer deposition method. Examples of other methods include electron beam deposition, sputter deposition, and coating.

As described above, in the electron tube 1, the base layer 21 having an electrical insulation property is made of a polycrystalline material. Thereby, the strength and the electrical insulation property of the entire insulating substrate 12 can be sufficiently secured. On the base layer 21 having an electrical insulation property, the intermediate layer 22 made of an amorphous material and having an electrical insulation property is provided. With the intermediate layer 22, it is possible to suppress incidence of electrons to the base layer 21, which is a polycrystalline material, and it is possible to suppress light emission from the base layer 21 due to incidence of the electrons. When the intermediate layer 22 having an electrical insulation property is located on the surface of the insulating substrate 12, the surface is easily charged. However, the electron tube 1 is provided with a surface layer 23 made of a material containing carbon and being smaller in electric resistance than the intermediate layer. Thereby, the electric resistance of the surface of the insulating substrate 12 becomes small, and charging on the surface can be suppressed. Therefore, the electron tube 1 can suppress both charging and light emission of the insulating substrate 12.

In the embodiment, the surface layer 23 contains an alkali metal. In particular, the surface layer 23, containing carbon, more easily contains an alkali metal. As described above, the surface layer 23 preferably incorporates an alkali metal that is a constituting material of the photoelectric surface 3 in the step of forming the photoelectric surface 3. However, the surface layer 23 may separately contain an alkali metal. When the surface layer 23 contains an alkali metal, the insulating substrate 12 can have a more appropriately reduced surface electric resistance. Therefore, it is possible to more reliably suppress the charging of the surface of the insulating substrate 12.

In the embodiment, the thickness T1 of the intermediate layer 22 is larger than the thickness T2 of the surface layer 23. When the thickness T1 of the intermediate layer 22 is sufficiently secured, incidence of electrons to the base layer 21 can be effectively suppressed. Therefore, it is possible to more reliably suppress light emission from the insulating substrate 12.

In the embodiment, the material containing carbon, which constitutes the surface layer 23, includes, as a base material, a material containing at least one of a metal oxide, a metal nitride, and a metal fluoride, and includes carbon in the base material. In this case, the electric resistance of the surface layer 23 can be appropriately smaller than that of the intermediate layer 22. In the embodiment, a material exhibiting an electrically insulating tendency (high electric resistance) is used as the base material, the base material contains carbon and an alkali metal, and further, the thickness T2 of the surface layer 23 is smaller than the thickness T1 of the intermediate layer 22 (that is, the thickness of the surface layer 23 is appropriately controlled), whereby appropriate adjustments have been made so that the electric resistance of the surface layer 23 is smaller than the electric resistance of the intermediate layer 22.

In the embodiment, the intermediate layer 22 and the surface layer 23 are provided at least on the first surface 21a and the second surface 21b of the base layer 21. In this case, when the insulating substrate 12 is provided with the intermediate layer 22 and the surface layer 23 on its surface to which electrons are easily incident, it is possible to effectively suppress both charging and light emission of the insulating substrate 12. Furthermore, in the embodiment, the intermediate layer 22 and the surface layer 23 are provided on the first surface 21a, the second surface 21b, the side surface 21c, and the inner surface of the insertion hole 13 of the base layer 21, respectively, and cover the entire surface of the base layer 21. Thereby, it is possible to further improve the effect of suppressing both charging and light emission throughout all positions of the insulating substrate 12.

When the intermediate layer 22 and the surface layer 23 are provided on the side surface 21c, the first surface 21a and the second surface 21b are electrically connected with each other, and thereby, it is possible to further reliably suppress charging of the surface of the insulating substrate 12, and it is possible to suppress light emission due to electron incidence to the side surface 21c. In addition, through the focusing electrode 5, the dynode 11 constituting the multiplier 4, and the anode 6, electrons multiply and pass. Therefore, electrons are easily incident to the vicinity of the insertion hole 13 into which the holding member 11b is inserted. However, when the intermediate layer 22 and the surface layer 23 are provided on the inner surface of the insertion hole 13, it is possible to further improve the effect of suppressing both charging and light emission of the insulating substrate 12.

Optionally, the intermediate layer 22 and the surface layer 23 are made of an identical material, and the content of an alkali metal in the intermediate layer 22 is smaller than the content of an alkali metal in the surface layer 23. For example, optionally, each of the intermediate layer 22 and the surface layer 23 is made of MgO (MgO containing carbon), the intermediate layer 22 is a poor layer of alkali metal and carbon, and the surface layer 23 is a rich layer of alkali metal and carbon, and thereby, the intermediate layer 22 has an electrical insulation property and the surface layer 23 has conductivity. According to such a configuration, when the intermediate layer 22 and the surface layer 23 are made of an identical material, it is possible to improve easiness in production of these layers, while suppressing both charging and issuing of the insulating substrate 12.

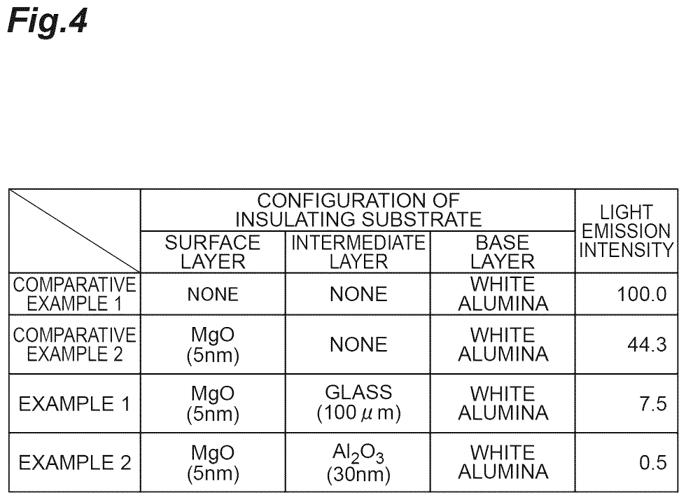

FIG. 4 is a chart showing the results of a confirmation test for the light emission-suppressing effect in the present disclosure. In the test shown in the chart, the light emission intensity in the ultraviolet region is calculated from the measured values when electrons are incident to the insulating substrate, changing the embodiment of the intermediate layer and the surface layer formed on the surface of the base layer. For calculating the light emission intensity, the acceleration voltage of electrons (electron beam) was 1 kV.

In Comparative Example 1, neither the intermediate layer nor the surface layer was provided, and the insulating substrate was constituted only by a base layer made of white alumina. In Comparative Example 2, the intermediate layer was not provided, and a surface layer made of carbon-containing MgO and having a thickness of 5 nm was formed on the surface of the base layer made of white alumina to constitute the insulating substrate. On the other hand, in Example 1, an intermediate layer made of glass and having a thickness of 100 μm and a surface layer made of carbon-containing MgO and having a thickness of 5 nm were formed on the surface of a base layer made of white alumina to constitute the insulating substrate. In Example 2, an intermediate layer made of alumina (Al₂O₃) and having a thickness of 30 nm and a surface layer made of carbon-containing MgO and having a thickness of 5 nm were formed on the surface of a base layer made of white alumina to constitute the insulating substrate.

As shown in FIG. 4, when the light emission intensity of the insulating substrate was 100 in Comparative Example 1, the light emission intensity of the insulating substrate was 44.3 in Comparative Example 2. From this result, it was found that even when only the surface layer made of carbon-containing MgO is provided on the base layer, the effect of suppressing the light emission intensity is exhibited to some extent. The light emission intensity in Examples 1 and 2 was calculated based on the attenuation rate of the light emission intensity of carbon-containing MgO having a thickness of 5 nm in Comparative Example 2. That is, the light emission intensity was calculated, assuming that when the film thickness of the intermediate layer and the surface layer is n times the thickness of carbon-containing MgO having a thickness of 5 nm, the attenuation rate thereof is 0.443 to the power of n. As a result, the light emission intensity of the insulating substrate was 7.5 in Example 1, and the light emission intensity of the insulating substrate was 0.5 in Example 2.

The electrical resistance of the surface layer made of MgO containing carbon is smaller than the electrical resistance of the intermediate layer. When an intermediate layer at a level of several tens of nm is provided on the surface of the base layer in Examples 1 and 2, the insulating substrate may be charged only with the intermediate layer. On the other hand, the further provided surface layer made of carbon-containing MgO and having a thickness of 5 nm solves the problem that the insulating substrate is charged when an intermediate layer having an electrical insulation property is positioned on the surface of the insulating substrate. From these results, it can be seen that the configuration according to the present disclosure in which the intermediate layer and the surface layer are provided on the surface of the base layer contributes to suppression of both charging and light emission of the insulating substrate.

### REFERENCE SIGNS LIST

1 Electron tube
2 Housing
3 Photoelectric surface
6 Anode (electrode)
11 Dynode (electrode)
12 Insulating substrate
13 Insertion hole
21 Base layer
21a First surface
21b Second surface
21c Side surface
22 Intermediate layer
23 Surface layer
T1 Thickness of intermediate layer
T2 Thickness of surface layer

1. An electron tube comprising:
a photoelectric surface converting incident light into photoelectrons;
a plurality of electrodes;
an insulating substrate holding the electrodes in a state where the electrodes are electrically insulated from each other; and
a housing accommodating the electrodes and the insulating substrate,
wherein the insulating substrate includes:
a base layer made of a polycrystalline material and having an electrical insulation property;
an intermediate layer made of an amorphous material and having an electrical insulation property; and
a surface layer made of a material containing carbon and being smaller in electric resistance than the intermediate layer.

2. The electron tube according to claim 1, wherein the surface layer further contains an alkali metal.

3. The electron tube according to claim 1, wherein a thickness of the intermediate layer is larger than a thickness of the surface layer.

4. The electron tube according to claim 1, wherein the material containing carbon includes, as a base material, a material containing at least one of a metal oxide, a metal nitride, and a metal fluoride, and includes carbon in the base material.

5. The electron tube according to claim 1, wherein the intermediate layer and the surface layer are provided at least on a first surface of the base layer on a side of the electrode and a second surface of the base layer on a side opposite to the electrode.

6. The electron tube according to claim 1, wherein the intermediate layer and the surface layer are provided on a side surface connecting the first surface and the second surface.

7. The electron tube according to claim 1, wherein the base layer has an insertion hole inserted with a holding member holding the electrode, and
the intermediate layer and the surface layer are provided on an inner surface of the insertion hole.

8. The electron tube according to claim 1, wherein the intermediate layer and the surface layer are provided on an entire surface of the base layer.

9. The electron tube according to claim 1, wherein the intermediate layer and the surface layer are made of an identical material, and
a content of an alkali metal in the intermediate layer is smaller than a content of an alkali metal in the surface layer.
